(19) United States
(12) Patent Application Publication
(10) Pub. No.: US 2012/0223196 A1
(43) Pub. Date: Sep. 6, 2012

(54) Apparatus and Method For Securing Mobile Devices

(76) Inventor: Bobby Musselman, Glendale, AZ (US)

(21) Appl. No.: 13/412,589

(22) Filed: Mar. 5, 2012

Related U.S. Application Data
(60) Provisional application No. 61/449,000, filed on Mar. 3, 2011.

(51) Int. Cl. F16M 13/02; B23P 11/00

(52) U.S. Cl. 248/220.21; 29/525.08

(57) ABSTRACT

An apparatus and method for securing a mobile device for quick and easy access is disclosed. The apparatus is removably mountable to handlebars, steering wheels, and other locations to allow the user to maintain the mobile device in a conveniently accessible location. Additionally, the apparatus comprises a flexible mounting bracket and an adjustable grip portion, allowing the apparatus to be easily adapted for use with a wide variety of mobile devices of many different shapes and sizes. The method of using the apparatus comprises the steps of mounting the apparatus to the desired location and then placing the mobile device into the adjustable grip portion of the apparatus, thereby securing the apparatus in the desired location.

### RELATED APPLICATION

The application claims priority benefit, with regards to all common subject matter, of earlier-filed U.S. provisional patent application Ser. No. 61/449,000, which application was filed on Mar. 3, 2011, which application is now pending and which application is incorporated herein by reference.

### BACKGROUND OF THE INVENTION

1. Technical Field

The present invention generally relates to mobile devices and various approaches for securing mobile devices for transport.

2. Background Art

The use of mobile devices (e.g., cell phones, personal digital assistants, media players, etc.) has grown exponentially over the last decade. The introduction and rapid adoption of various types of mobile devices has changed the way people communicate, recreate, and work.

With the proliferation of the various mobile devices, the emergence of after-market products and accessories for the mobile devices has also shown exponential growth. For example, carrying cases, ear phones, auxiliary speakers, bags, screen protectors, etc. now appear in ever increasing numbers.

People are constantly searching for the best and most effective accessories that will allow them to use their mobile devices in the manner that will fit their lifestyle, needs and desires.

Against this backdrop, there remains a need for additional accessories that will allow a person to easily and effectively have their mobile device available at all times and in all places, to the extent desired. Accordingly, without improvements to the current state of the art for securing mobile devices, the use and operation of these devices will continue to be suboptimal.

### BRIEF SUMMARY OF THE INVENTION

An apparatus and method for securing a mobile device for quick and easy access is disclosed. The apparatus is removably mountable to handlebars, steering wheels, and other similar locations to allow the user to maintain the mobile device in a conveniently accessible location. Additionally, the apparatus comprises a flexible mounting bracket and an adjustable grip portion, allowing the apparatus to be easily adapted for use with a wide variety of mobile devices of many different shapes and sizes. The method of using the apparatus comprises the steps of mounting the apparatus to the desired location and then placing the mobile device into the adjustable grip portion of the apparatus, thereby securing the apparatus in the desired location.

### BRIEF DESCRIPTION OF THE FIGURES

The preferred embodiments of the present invention will hereinafter be described in conjunction with the appended drawings, wherein like designations denote like elements, and:

FIG. 1 shows a perspective view of the back and right side of an apparatus for securing mobile devices in accordance with a preferred exemplary embodiment of the present invention;

FIG. 2 shows an rear view of an apparatus for securing mobile devices in accordance with a preferred exemplary embodiment of the present invention;

FIG. 3 shows a side view of an apparatus for securing mobile devices in accordance with a preferred exemplary embodiment of the present invention;

FIG. 4 shows a top view of an apparatus for securing mobile devices in accordance with a preferred exemplary embodiment of the present invention;

FIG. 5 shows an rear view of an apparatus for securing mobile devices in accordance with a preferred exemplary embodiment of the present invention, with a section line;

FIG. 6 shows a sectional side view of an apparatus for securing mobile devices in accordance with a preferred exemplary embodiment of the present invention taken along the section line showed in FIG. 5;

FIG. 7 shows a detail view of an adjustment mechanism for an apparatus for securing mobile devices in accordance with a preferred exemplary embodiment of the present invention taken from the cutaway view of FIG. 6;

FIG. 8 shows a perspective view of the front and right side or an apparatus for securing mobile devices in accordance with a preferred exemplary embodiment of the present invention;

FIG. 9 shows a perspective view of the back and right side of an apparatus for securing mobile devices in accordance with a preferred exemplary embodiment of the present invention;

FIG. 10 shows a perspective view of the front and right side of an apparatus for securing mobile devices in accordance with an alternative preferred exemplary embodiment of the present invention;

FIG. 11 shows a perspective view of the back and right side of an apparatus for securing mobile devices in accordance with an alternative preferred exemplary embodiment of the present invention;

FIG. 12 shows a side view of an apparatus for securing mobile devices in accordance with an alternative preferred exemplary embodiment of the present invention;

FIG. 13 is a side view of an apparatus for securely holding a mobile device in accordance with a preferred exemplary embodiment of the present invention;

FIG. 14 is a perspective view of a vehicle steering wheel with an apparatus for securely holding a mobile device in accordance with a preferred exemplary embodiment of the present invention affixed thereto;

FIG. 15 is an exploded view of security band used in conjunction with an apparatus for securely holding a mobile device in accordance with an alternative preferred exemplary embodiment of the present invention;

FIG. 16 is a perspective view of an apparatus for securely holding a mobile device in accordance with an alternative preferred exemplary embodiment of the present invention showing the security band in place;

FIG. 17 is a bottom view of an apparatus for securely holding a mobile device in accordance with an alternative preferred exemplary embodiment of the present invention;

FIG. 18 is a back view of an apparatus for securely holding a mobile device in accordance with an alternative preferred exemplary embodiment of the present invention;

FIG. 19 is a side view of an apparatus for securely holding a mobile device in accordance with an alternative preferred exemplary embodiment of the present invention;

FIG. 20 is a front view of an apparatus for securely holding a mobile device in accordance with an alternative preferred exemplary embodiment of the present invention;

FIG. 21 is a top view of an apparatus for securely holding a mobile device in accordance with an alternative preferred exemplary embodiment of the present invention;

FIG. 22 shows a sectional line for the apparatus for securely holding a mobile device in accordance with an alternative preferred exemplary embodiment of the present invention shown in FIG. 18.

FIG. 23 is a sectional view of the apparatus for securely holding a mobile device in accordance with an alternative preferred exemplary embodiment of the present invention of FIG. 22; and

FIG. 24 is a detail view of the lower engagement mechanism of FIG. 23.

### DETAILED DESCRIPTION

An apparatus and method for securing a mobile device for quick and easy access is disclosed. The apparatus is removably mountable to handlebars, steering wheels, and other locations to allow the user to maintain the mobile device in a conveniently accessible location. Additionally, the apparatus comprises a flexible mounting bracket and an adjustable grip portion, allowing the apparatus to be easily adapted for use with a wide variety of mobile devices of many different shapes and sizes. The method of using the apparatus comprises the steps of mounting the apparatus to the desired location and then placing the mobile device into the adjustable grip portion of the apparatus, thereby securing the apparatus in the desired location.

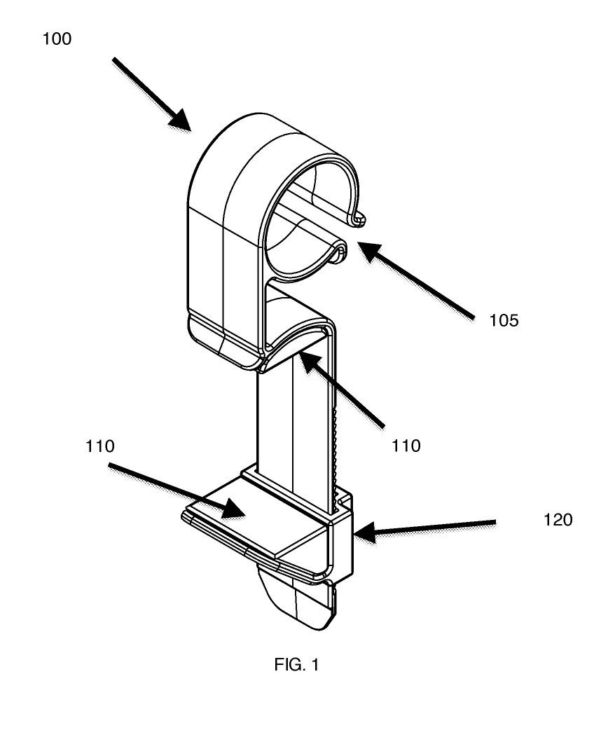

Referring now to FIG. 1, a perspective view of the back and right side of an apparatus 100 for securing mobile devices in accordance with a preferred exemplary embodiment of the present invention is depicted. As shown in FIG. 1, apparatus 100 comprises an anchor mechanism 105, a plurality of cushioning members 110, and an adjustable gripping mechanism 120.

Apparatus 100 is most preferably manufactured from a durable, resilient, flexible yet material. Most preferably, some type of plastic will be the preferred material. Anchor mechanism 105 is configured to be removably attached to any suitable anchor point. For example, a steering wheel, the handlebars of a bicycle or motorcycle, the handle of a stroller, etc.

Cushioning members 110 are more preferably manufactured from a durable, dense, sponge-like or foam-like material so as to prevent any damage to the exterior case or surface of the mobile device that is being held in gripping mechanism 120.

Anchor mechanism 105 comprises a substantially circular opening, with a break in the circumference of the circular opening to allow for the insertion of a portion of an anchor point into the interior space of anchor mechanism 105.

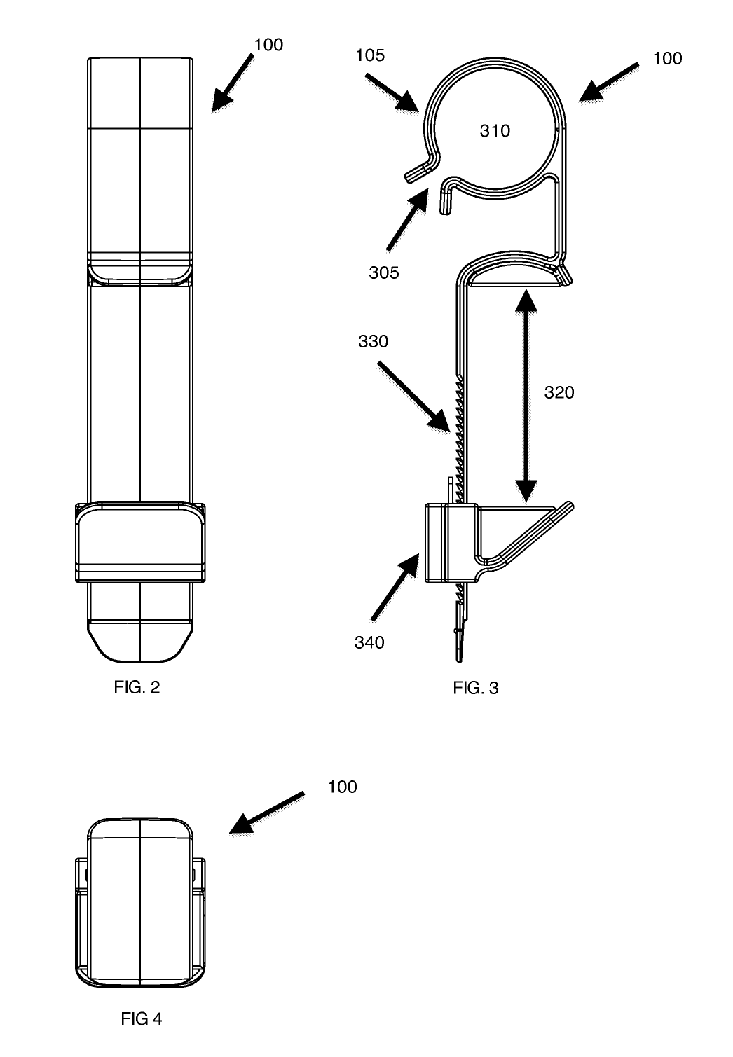

Referring now to FIG. 2, a rear view of apparatus 100 of FIG. 1 for securing mobile devices in accordance with a preferred exemplary embodiment of the present invention is depicted.

Referring now to FIG. 3, a side view of apparatus 100 of FIG. 1 for securing mobile devices in accordance with a preferred exemplary embodiment of the present invention is depicted. The body portion of apparatus 100 comprises a series of ridges or “teeth” 330 that engage a corresponding protrusion or “tab portion” in adjustment mechanism 340. The protrusion is normally urged towards teeth 330 thereby engaging teeth 330 and “locking” adjustment mechanism 340 firmly in place.

The protrusion may be selectively manipulated and disengaged from teeth 330. Once disengaged, and for so long as the protrusion is disengaged from teeth 330, adjustment mechanism 340 can be selectively repositioned. Once the protrusion is released, the protrusion will re-engage teeth 330, thereby “locking” adjustment mechanism 340 into place. This process can be repeated as often as necessary.

As shown in FIG. 3, a distance 320 is defined by the space between opposing cushioning members 110. This distance can be expanded or reduced by grasping the tab portion of adjustment mechanism 340, pulling it out and away to disengage the teeth, and moving adjustment mechanism 340 up or down, towards or away from anchor mechanism 105.

The interior space 310 defined by the circular portion of anchor mechanism 105 is configured to receive a substantially circular anchor point. For example, the steering wheel of a car, the handlebars of a bicycle or motorcycle or the handle of a stroller. The inner diameter of anchor mechanism 105 is slightly smaller than the exterior diameter of the anchor point that is inserted into interior space 310. The material comprising anchor mechanism 105 is flexible and resilient enough to bend, deform, or deflect, but not break, when the anchor point is forcibly inserted through the opening 305 defined by the perimeter of anchor mechanism 105. This allows opening 305 to be temporarily enlarged enough so that the anchor point may be inserted through opening 305 and into interior space 310.

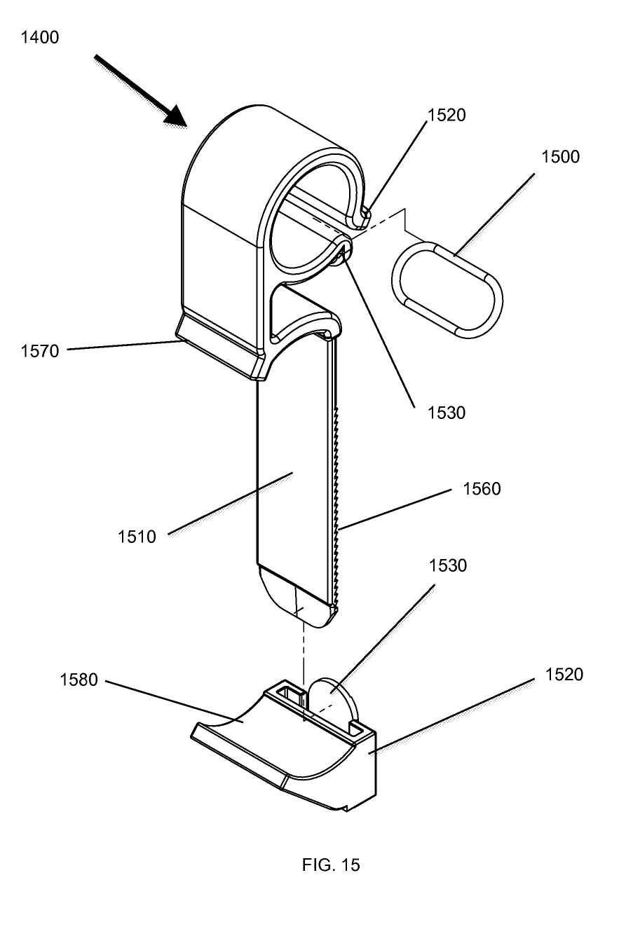

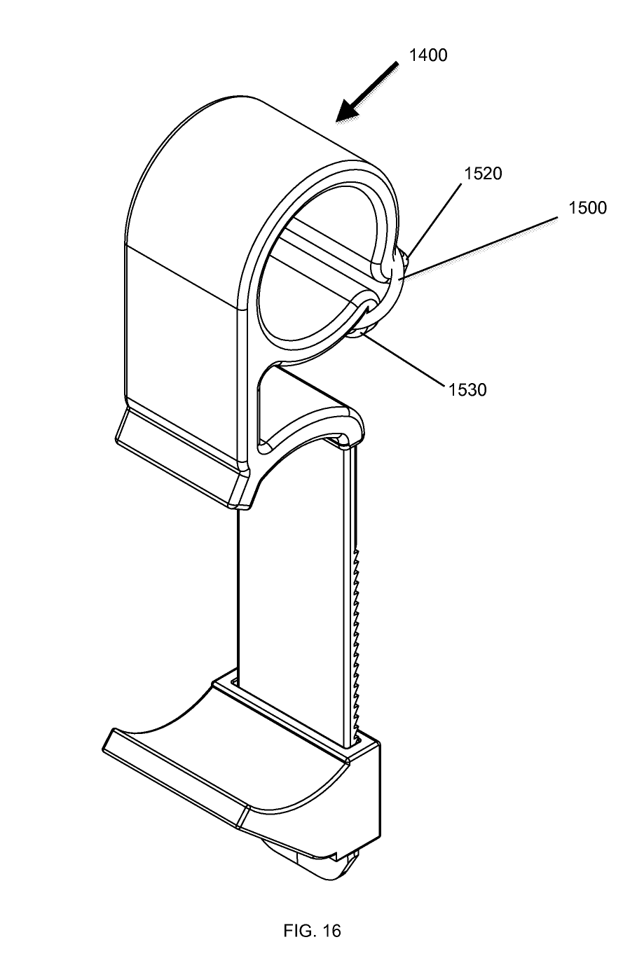

Once the anchor point has passed opening 305 and has entered interior space 310, opening 305 “snaps” back into its original position, thereby enclosing the outer perimeter of the anchor point. This securely fastens apparatus 100 to the anchor point. As shown below in FIG. 15 and FIG. 16, in certain applications, it may be desirable to add a selectively removable security band to further stabilize anchor mechanism 105.

Referring now to FIG. 4, a top view of apparatus 100 of FIG. 1 for securing mobile devices in accordance with a preferred exemplary embodiment of the present invention is depicted.

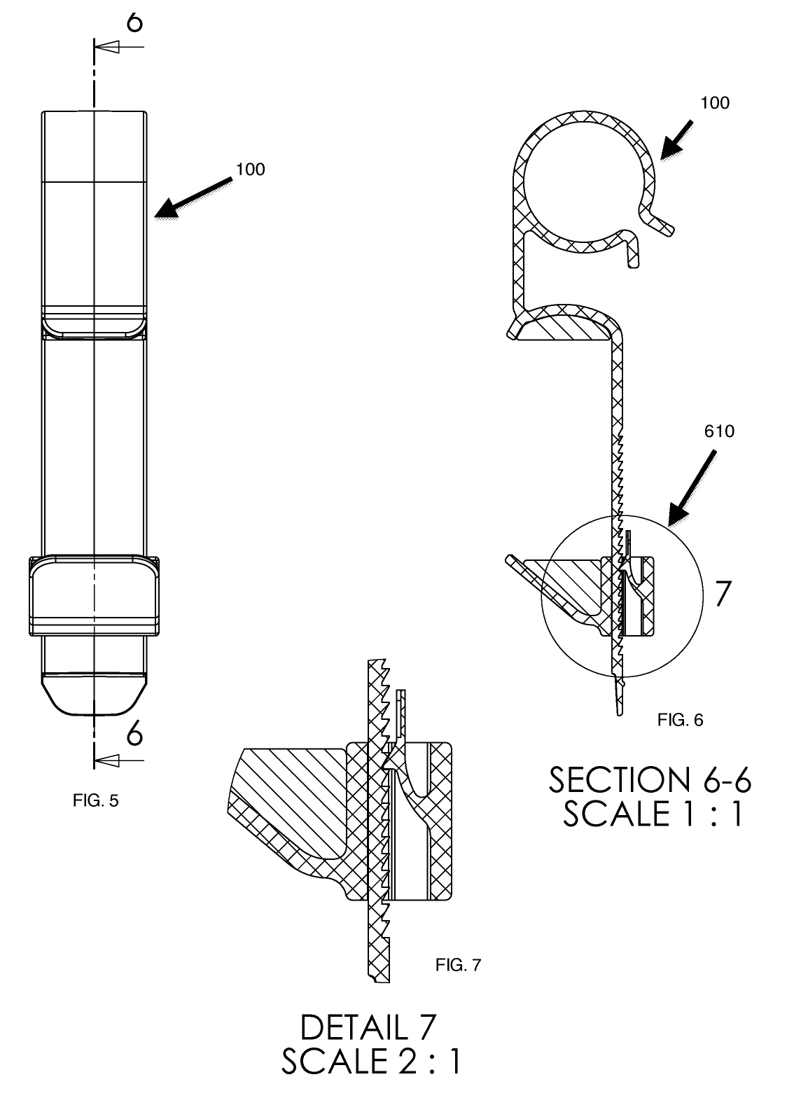

Referring now to FIG. 5, a rear view of apparatus 100 of FIG. 1 for securing mobile devices in accordance with a preferred exemplary embodiment of the present invention, with a section line is depicted.

Referring now to FIG. 6, a sectional side view of apparatus 100 of FIG. 1 for securing mobile devices in accordance with a preferred exemplary embodiment of the present invention taken along the section line showed in FIG. 5 is depicted.

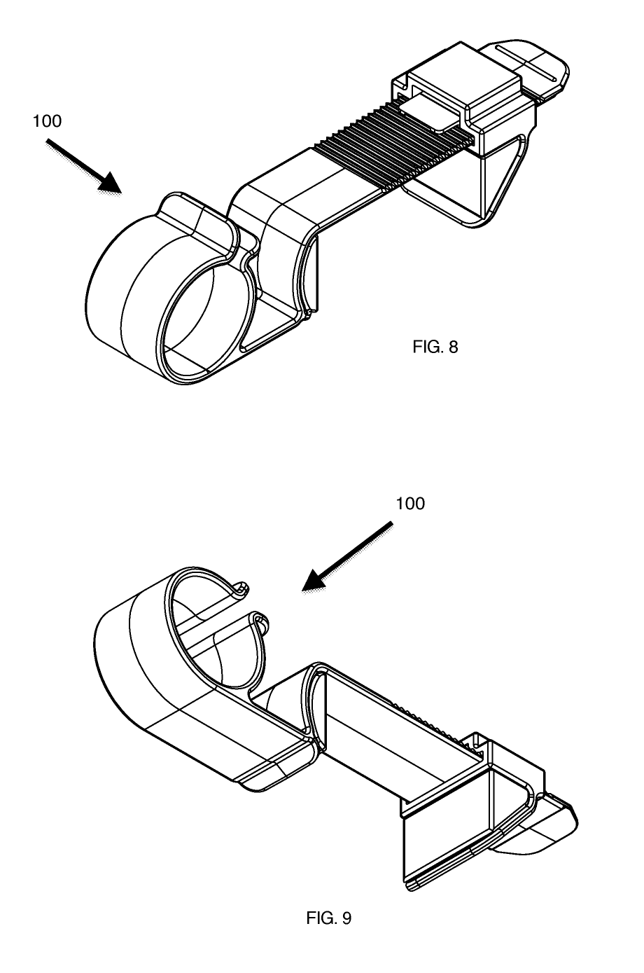

Referring now to FIG. 7, a detail view of an adjustment mechanism for apparatus 100 of FIG. 1 for securing mobile devices in accordance with a preferred exemplary embodiment of the present invention taken from the cutaway view of FIG. 6 is depicted.

Referring now to FIG. 8, a perspective view of the front and right side of apparatus 100 of FIG. 1 for securing mobile devices in accordance with a preferred exemplary embodiment of the present invention is depicted.

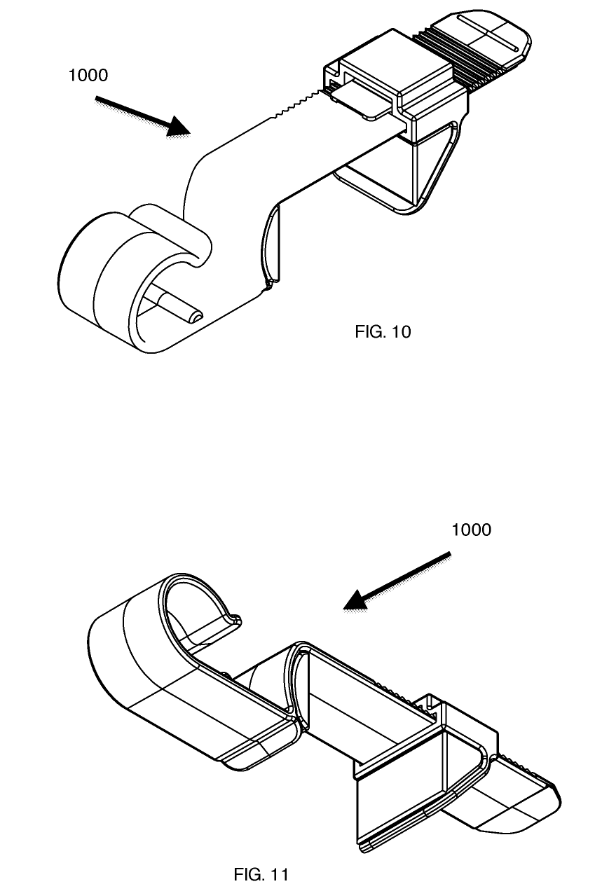

Referring now to FIG. 9, a perspective view of the back and right side of apparatus 100 of FIG. 1 for securing mobile devices in accordance with a preferred exemplary embodiment of the present invention is depicted.

Referring now to FIG. 10, a perspective view of the front and right side of an apparatus for securing mobile devices in accordance with an alternative preferred exemplary embodiment of the present invention is depicted.

Referring now to FIG. 11, a perspective view of the back and right side of an apparatus for securing mobile devices in accordance with an alternative preferred exemplary embodiment of the present invention is depicted.

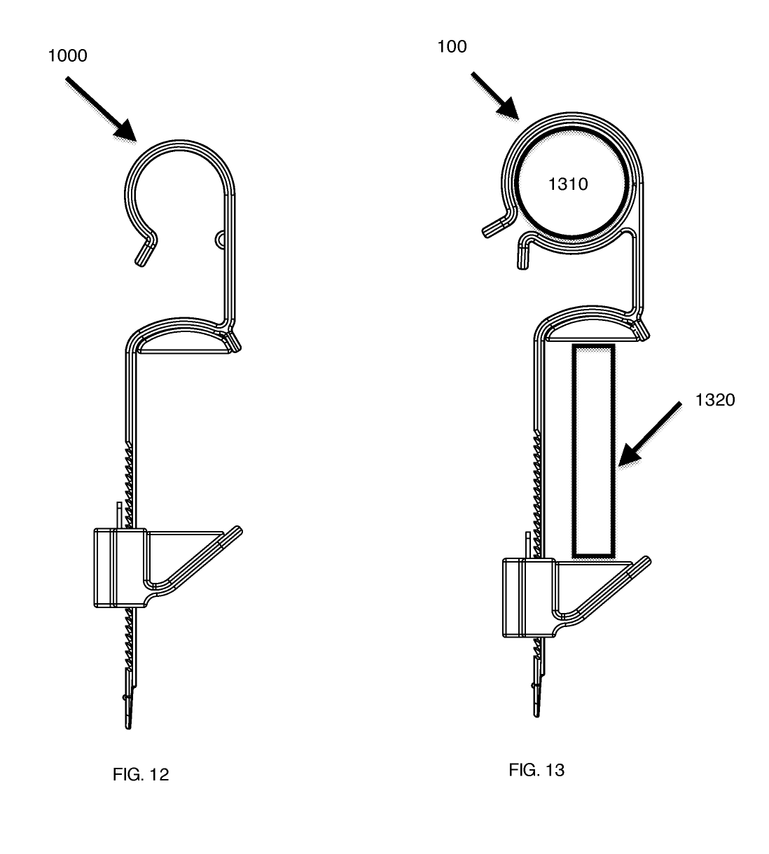

Referring now to FIG. 12, a side view of an apparatus for securing mobile devices in accordance with an alternative preferred exemplary embodiment of the present invention is depicted.

Referring now to FIG. 13, a side view of the apparatus of FIG. 1 for securely holding a mobile device in accordance with a preferred embodiment of the present invention is depicted. As shown in FIG. 13, an anchor point 1310 has been inserted into anchor mechanism 105. Additionally, a mobile device 1320 has been securely positioned or “pinched” in place between opposing cushioning members 110. In this fashion, mobile device 1320 can be selectively attached to many different locations, allowing additional flexibility for the owner of mobile device 1320 as well as “hands free” operation of mobile device 1320.

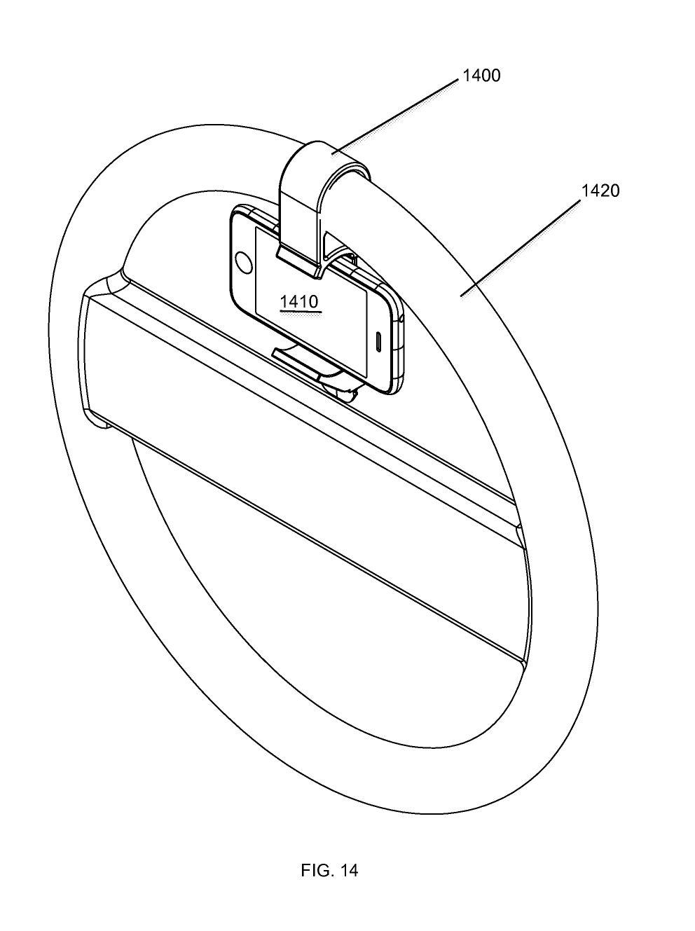

Referring now to FIG. 14 is a perspective view of a vehicle steering wheel 1420 with an apparatus 1400 for securely holding a mobile device 1410 in accordance with an alternative preferred exemplary embodiment of the present invention affixed thereto is depicted. As shown in FIG. 14, vehicle steering wheel 1420 serves as an anchor point for apparatus 1400, which in turn, secures mobile device 1410 in position where it may be viewed and or accessed, as necessary.

Referring now to FIG. 15 is an exploded view of security band 1500 used in conjunction with an apparatus 1400 for securely holding a mobile device in accordance with an alternative preferred exemplary embodiment of the present invention is depicted. Security band 1500 is manufactured from a durable and resilient elastic material. This provides the necessary elastic extension and compression characteristics, similar to a rubber band, that will assist the user in securing apparatus 1400 to one or more anchor points.

As shown in FIG. 15, lips 1520 and 1530 may be secured by positioning security band 1500 so that it is substantially positioned over and around lips 1520 and 1530. Since security band 1500 has an elastic property, it may be stretched out to encircle lips 1520 and 1530. Then, when released, security bank 1500 will “snap back” to its original size and exert pressure on lips 1520 and 1530, drawing them close together so as to more securely hold apparatus 1400 in place on the selected anchor point. This will serve to further protect against any inadvertent dislodgement of apparatus 1400 from the selected anchor point.

Tongue portion 1510 is removably inserted into housing 1520 where teeth 1560 are engaged. Once teeth 1560 are engaged within 1520, tongue portion 1510 will be held in position by a cooperating ridge or tooth positioned within housing 1520, thereby securing tongue portion 1510 in the desired position.

Once tongue portion 1510 has been positioned inside housing 1520, tongue portion 1510 may be repositioned as desired, using tab 1530. By depressing tab 1530, teeth 1560 may be temporarily disengaged from the ratcheting mechanism contained within housing 1520, allowing tongue portion 1510 to be repositioned to the desired location to accommodate various sizes of mobile devices. Additional detail on the engagement of teeth 1560 is presented below in conjunction with FIG. 23 and FIG. 24.

Anchor elements 1570 and 1580 are slightly curved or angled so as to more securely hold a mobile device in apparatus 1400. In the most preferred embodiments of the present invention, anchor elements 1570 and 1580 are cushioned or coated with a rubberized cushioning material so as to avoid causing any scratching or other damage to the exterior case of a mobile device being held in apparatus 1400. By adjusting the location of tongue portion 1520 within housing 1520, anchor elements 1570 and 1580 may be positioned closer together or further apart, thereby allowing apparatus 1400 to accommodate many different sizes and shapes of mobile devices.

Referring now to FIG. 16 is a perspective view of an apparatus 1400 for securely holding a mobile device in accordance with an alternative preferred exemplary embodiment of the present invention showing security band 1500 in place is depicted. As shown in FIG. 16, security band 1500 has been positioned over lips 1520 and 1530, minimizing the possible of separation and inadvertent dislodgement of apparatus 1400 from the desired anchor point.

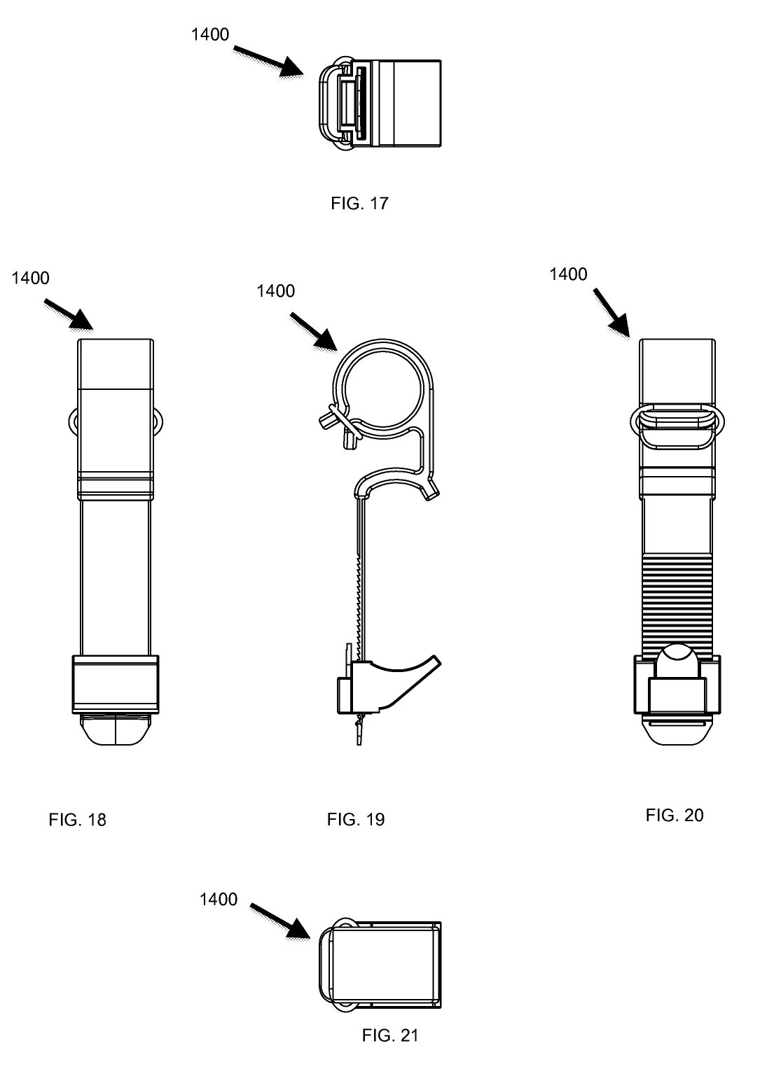

Referring now to FIG. 17 is a bottom view of an apparatus 1400 for securely holding a mobile device in accordance with an alternative preferred exemplary embodiment of the present invention is depicted.

Referring now to FIG. 18 is a back view of an apparatus 1400 for securely holding a mobile device in accordance with an alternative preferred exemplary embodiment of the present invention is depicted.

Referring now to FIG. 19 is a side view of an apparatus 1400 for securely holding a mobile device in accordance with an alternative preferred exemplary embodiment of the present invention is depicted.

Referring now to FIG. 20 is a front view of an apparatus 1400 for securely holding a mobile device in accordance with an alternative preferred exemplary embodiment of the present invention is depicted.

Referring now to FIG. 21 a top view of an apparatus 1400 for securely holding a mobile device in accordance with an alternative preferred exemplary embodiment of the present invention is depicted.

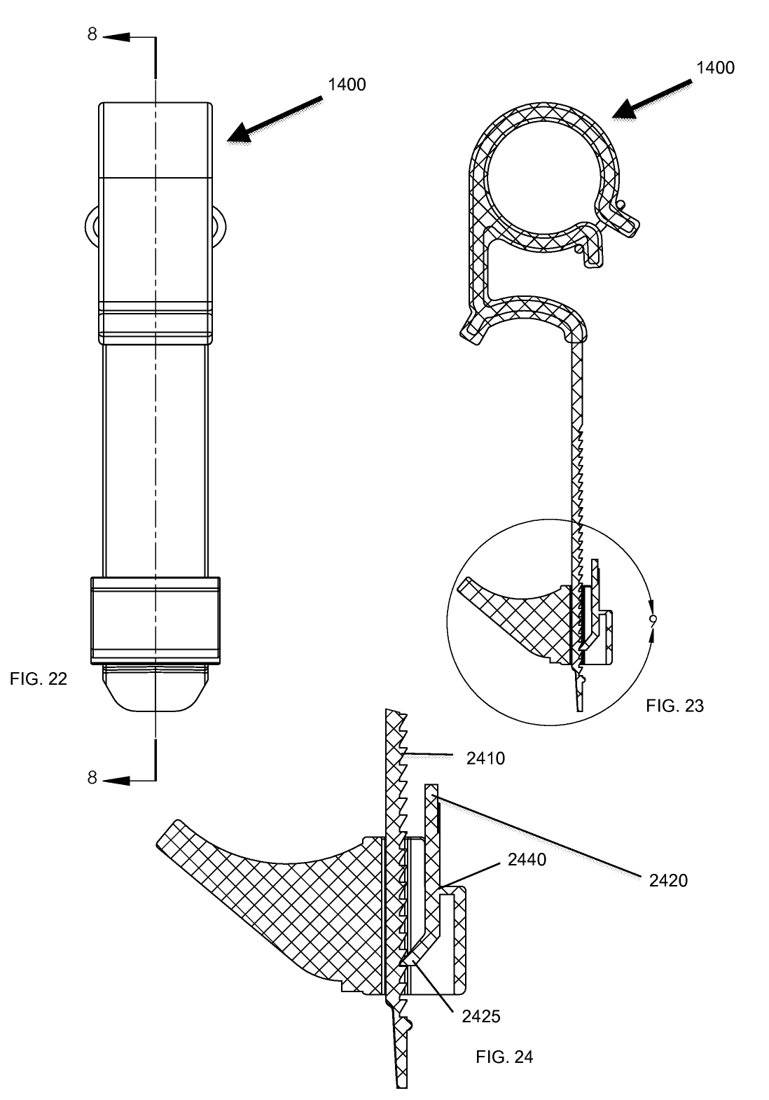

Referring now to FIG. 22 shows a sectional line for the apparatus 1400 for securely holding a mobile device in accordance with an alternative preferred exemplary embodiment of the present invention shown in FIG. 18.

Referring now to FIG. 23 is a sectional view of the apparatus 1400 for securely holding a mobile device in accordance with an alternative preferred exemplary embodiment of the present invention of FIG. 22; and

Referring now to FIG. 24 is a detail view of the lower engagement mechanism of the apparatus 1400 for securely holding a mobile device in accordance with an alternative preferred exemplary embodiment of the present invention shown in FIG. 23. As shown in FIG. 24, teeth 2410 are engaged by ridge or tooth 2425, in a ratchet fashion. By pushing tab 2420 towards teeth 2410, ridge 2425 is displaced laterally away from teeth 2410 at lever or pivot point 2440, thereby disengaging teeth 2410 from ridge 2425, allowing teeth 2410 to be repositioned as desired. Once the desired position has been obtained, tab 2420 is released and ridge 2425 is re-engaged with teeth 2410.

From the foregoing description, it should be appreciated that an enhanced apparatus and methods for securing a mobile device in a variety of unique ways is provided by the various preferred embodiments of the present invention and that the various preferred embodiments offer significant benefits that would be apparent to one skilled in the art. Furthermore, while multiple preferred embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

What is claimed is:

1. An apparatus comprising:
an adjustable gripping mechanism, the adjustable gripping mechanism being configured to securely grip a mobile device; and
an anchor engagement mechanism, the anchor engagement mechanism being configured to be removably attached to an anchor point.

2. A method of removably affixing a mobile device to an object comprising the steps of:
anchoring an apparatus to the object, the apparatus comprising:
an anchor engagement mechanism; and
an adjustable gripping mechanism;
placing the mobile device in the adjustable gripping mechanism; and
adjusting the adjustable gripping mechanism so as to securely clamp the mobile device in place.
